(19) United States
(12) Patent Application Publication
(10) Pub. No.: US 2012/0158277 A1
(43) Pub. Date: Jun. 21, 2012

(54) Method and System for Preparing the Taxiing Phase for an Aircraft in an Airport Area

(75) Inventors: Pascal GAYRAUD, Toulouse (FR); Nicolas MARTY, Saint Sauveur (FR); Julia PERCIER, CUGNAUX (FR)

(73) Assignee: THALES, Neuilly-sur-Seine (FR)

(21) Appl. No.: 13/327,672

(22) Filed: Dec. 15, 2011

(30) Foreign Application Priority Data
Dec. 17, 2010 (FR) 10 04938

(51) Int. Cl. G08G 5/06

(52) U.S. Cl. 701/120

(57) ABSTRACT

A method and a system is provided for preparing the taxiing phase for an aircraft on the basis of an airport database cataloguing by section, the taxiways of an airport and storing, for each section, specific data of geographical position and of connectivity and of a taxiing plan for the aircraft indicating a succession of taxiway sections. The method comprises a step of detecting risk areas along the taxiing plan and a step of displaying the detected risk areas.

### CROSS-REFERENCE TO RELATED APPLICATION

This application claims priority to foreign French patent application No. FR 1004938, filed on Dec. 17, 2010, the disclosure of which is incorporated by reference in its entirety.

### FIELD OF THE INVENTION

The invention relates to assistance aiding the pilot during the phase of ground movement of an aircraft in an airport, and more particularly during the phase of preparing this movement.

### BACKGROUND

The complexity of large airport platforms, associated with significant and fast-growing traffic, is causing the taxiing phase to be an increasingly tricky phase for pilots notably when they have limited experience of an airport and its constraints. The pilot must manoeuvre the aeroplane on a course comprising numerous intersections while monitoring the traffic, while adhering to the controller's taxiing authorizations, usually referred to as clearances, and while performing preparation for takeoff. This may cause errors of assessment, and the aeroplane may be situated in areas where it is not authorized, entailing risks of collisions.

On modern aircraft, to ensure the airport navigation function, two types of systems exist for aiding ground travel. These are:
A system for aiding navigation allowing the pilot to ascertain the position of the aircraft in the airport at any moment. Provision is made moreover for this system to indicate to him which route to follow so as to get from one point to another in the airport (this function is undergoing development). Generally the useful information is presented on a so-called head-down instrument panel display. This information comprises: a moving electronic map of the airport, the position of the aircraft on the airport maneuvering zone. Provision is also made to add the following information: the taxiing course to be followed and the stopping points, the latter correspond to the taxiing authorizations provided by ground control.
A system for aiding taxiing allowing the pilot to follow, as closely as possible, the setpoint trajectory coming from the control.
Such systems make it possible to enhance safety during the taxiing phase. But there exists a requirement to further improve safety during this phase during preparation, to anticipate points where confusion or an error are prone to occur.

### SUMMARY OF THE INVENTION

In one aspect, the invention alleviates the problem cited previously by proposing a method and system for preparing the taxiing phase for an aircraft in an airport area making it possible to enhance the safety of the taxiing phase by detecting by displaying risk areas along the plan of the aircraft.

For this purpose, the subject of the invention is a method for preparing the taxiing phase for an aircraft on the basis of an airport database cataloguing by section, the taxiways of an airport and storing, for each section, specific data of geographical position and of connectivity and of a taxiing plan for the aircraft indicating a succession of taxiway sections, the said method being characterized in that it comprises:
a step of detecting risk areas along the taxiing plan comprising at least one of the following sub-steps:
   the detection of sections adjacent to the taxiing plan forming an angle, with a section of the taxiing plan, that is smaller than a first threshold θₘᵢₙ,
   the detection of sections of the taxiing plan comprising a number of connections with other sections that is greater than a second threshold Nₘₐₓ,
   the detection of the sections of the taxiing plan being in connection with a section connected to a runway,
a step of displaying the detected risk areas.

By virtue of the invention, the pilot of the aircraft can thus view, before the taxiing phase, the taxiing plan that he will have to follow. The taxiing plan presented to the pilot comprises indications pointing up risk areas. The pilot is thus alerted that he will have to show evidence of particular vigilance at these areas. The safety of the taxiing phase is thus improved.

Advantageously, the step of displaying the detected risk areas comprises the displaying on an airport map representing the taxiways, of symbols at the detected risk areas.

Advantageously, the displaying of the taxiing plan comprising a list of sections, the displaying step comprises for each detected risk area, the displaying of a vigilance message signalling the section associated with the detected risk area.

Advantageously, the method comprises a step of selecting the vigilance messages making it possible to centre the airport map on the risk area corresponding to the selected vigilance message.

Advantageously, the method furthermore comprises a step of acquiring areas at high risk of runway incursion originating from a base of areas at high risk of runway incursion.

The invention also relates to a system for preparing the taxiing phase for an aircraft comprising an airport database cataloguing by section, the taxiways of an airport and storing, for each section, specific data of geographical position and of connectivity, and a taxiing function calculating a taxiing plan for the aircraft indicating a succession of taxiway sections, the said system being characterized in that it comprises:
a device adapted to the detection of risk areas along the taxiing plan on the basis of the data of the airport database and of the taxiing plan comprising at least one of the following means:
   means adapted to the detection of sections adjacent to the taxiing plan forming an angle, with a section of the taxiing plan, that is smaller than a first threshold (θ),
   means adapted to the detection of sections of the taxiing plan comprising a number of connections with other sections that is greater than a second threshold (N),
   means adapted to the detection of the sections of the taxiing plan being in connection with a section connected to a runway,
means 104 adapted to the displaying of the detected risk areas.

Advantageously, the means adapted to the displaying 104 of the detected risk areas comprise an airport map representing the taxiways and symbols at the detected risk areas.

Advantageously, the means adapted to the displaying 104 of the detected risk areas comprise a list of sections of the taxiing plan and, for each detected risk area, a vigilance message signalling the section associated with the detected risk area.

Advantageously, the system furthermore comprises means for selecting the displayed vigilance messages, and means for the synchronization of the displaying of the airport map with the said means for selecting the vigilance messages, configured so that the airport map is centred on the risk area corresponding to the selected vigilance message.

Advantageously, the system furthermore comprises means for the acquisition of data originating from a base of areas at high risk of runway incursion in which the means adapted to the displaying of the detected risk areas furthermore display the areas at high risk of runway incursion.

### BRIEF DESCRIPTION OF THE DRAWINGS

The invention will be better understood and other advantages will become apparent on reading the detailed description given by way of nonlimiting example and with the aid of the figures among which:

FIG. 1 represents the system according to the invention as well as the main functions of the method and the avionics devices making it possible to implement the method according to the invention;

FIG. 2 presents a first example of a taxiing plan;

FIG. 3 presents a second example of a taxiing plan;

FIG. 4 presents an exemplary display of symbols on an airport map at detected risk areas;

FIG. 5 illustrates an exemplary display of a list of section comprising the vigilance information or risk areas;

FIG. 6a shows a first example of selecting a vigilance message in the list of path sections representing a taxiing plan;

FIG. 6b shows a second example of selecting a vigilance message still in even the list of path sections.

### DETAILED DESCRIPTION

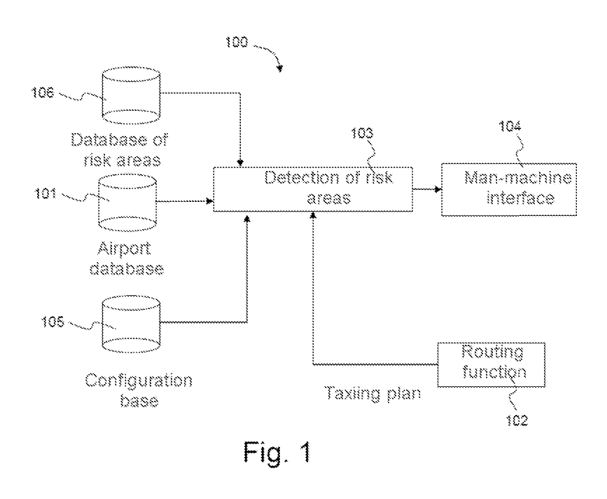

FIG. 1 represents the system according to the invention as well as the main functions of the method and the avionics devices making it possible to implement the method according to the invention.

The system 100 according to the invention comprises an airport database 101 comprising data relating to the taxiways of the airport which are catalogued in the form of sections. The database 101 also comprises for each section specific data of geographical position and of connectivity, these data making it possible to ascertain the intersections between sections. The system 100 comprises a taxiing function 102 calculating a taxiing plan for the aircraft indicating a succession of taxiway sections.

The system also comprises a device adapted to the detection 103 of risk areas along the taxiing plan. This device recovers the data of the airport base and the taxiing plan. The device adapted to the detection 103 of risk areas along the taxiing plan comprises at least one of the following means:
means adapted to the section detection adjacent to the taxiing plan forming an angle, with a section of the taxiing plan, that is smaller than a first threshold θₘᵢₙ,
means adapted to the detection of the sections of the taxiing plan comprising a number of connections with other sections that is greater than a second threshold Nₘₐₓ,
means adapted to the detection of the sections of the taxiing plan being in connection with a section connected to a runway.

The device also comprises means adapted to the displaying 104 of the detected risk areas.

The invention comprises a configuration function making it possible to parametrize which detection means is activated in the detection device. The configuration may activate only one of the means, only two means or the three means at the same time.

The system which is on board makes it possible to detect the transits judged to be tricky, or indeed dangerous during the taxiing phase, on account of the configuration of the various taxiways and runways.

The dangerousness is signalled to the taxiing scheduling system and to the viewing system.

The method according to the invention comprises a step of detecting risk areas along the taxiing plan on the basis of an airport database, and optionally of a database of risk areas of the airport. This step implements predetermined thresholds defined in a configuration base 105.

The method furthermore comprises a step of displaying the detected risk areas.

The airport database 101 catalogues by section, the taxiways of the airport and stores, for each section, specific data of geographical position and of connectivity. The airport database 101 describes the mapping of the airport such as standardized in the document ARINC-816 as well as additional information regarding the connectivity of the sections. It contains in particular the location of all the visual elements and their attachment to a physical entity of the airport through a container, like a taxiway or a runway for example. The set of containers and elements included in the database are described in ARINC-816. Beyond the simple grouping of the data into containers, the base used ensures the chain of connectivity of the airport elements.

The taxiing plan originates from a taxiing function 102 also called system for aiding navigation during taxiing. The taxiing plan for the aircraft indicates a succession of taxiway sections to be followed.

The taxiing plan is traversed from the boarding area to the takeoff runway during the takeoff phase and from the landing runway to the passenger disembarkation area during the landing phase.

The means adapted to the displaying 104 of the detected risk areas comprises an MMI the function of which is to present the aircraft's taxiing plan to the crew. The role of the MMI is also to present to the crew the vigilance messages relating to the taxiing plan, notably the detected risk areas. The MMI comprises a user interface which comprises an input interface or “Interactive CDS” such as for example a “track ball”, a cursor, or a keyboard etc., and an output interface, typically a cockpit display system or CDS. The MMI is linked directly to the device adapted to the detection 103 of risk areas.

The step of determining the risk areas comprises at least one of the following sub-steps:
the detection of sections adjacent to the taxiing plan forming an angle, with a section of the taxiing plan, that is smaller than a first threshold θₘᵢₙ,
the detection of sections of the taxiing plan comprising a number of connections with other sections that is greater than a second threshold Nₘₐₓ,
the detection of the sections of the taxiing plan being in connection with a section connected to a runway.

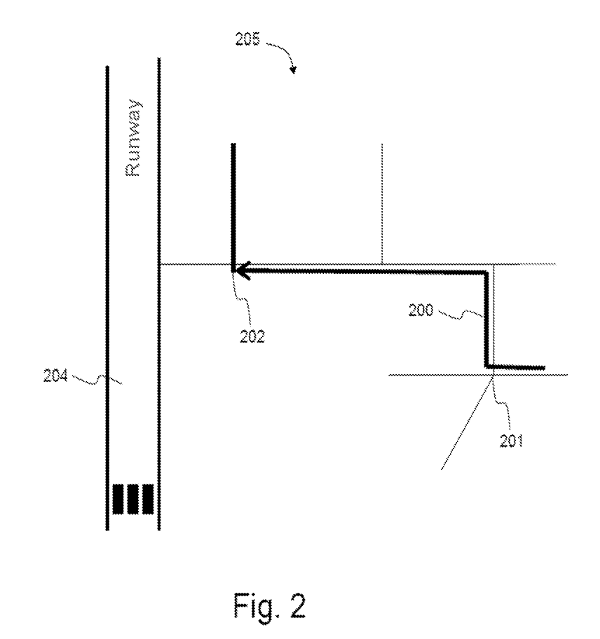

FIG. 2 presents a first example of a taxiing plan 200. The figure shows a map of the airport 205 signalling the taxiways indicated in the airport database 101. The taxiing plan 200 is signalled by a thick line and by an arrow signalling the direction of travel of the aircraft. The figure also shows two risk areas 201, 202 detected along the taxiing plan.

The first risk area 201 corresponds to a section comprising a number of connections with other sections that is greater than a second threshold Nₘₐₓ. This signalling makes it possible to attract the pilot's attention regarding the fact that he will encounter a crossroad comprising numerous pathways and thus to prevent him from taking a wrong branch.

In practice the detection of the sections of the taxiing plan comprising a number of connections with other sections that is greater than a second threshold may be carried out for example:

By examining each section of the taxiing plan and for each of the sections, by examining each of its ends, by counting the number of sections to which this end is linked and by comparing this number with a second predetermined threshold Nₘₐₓ.

If the number of sections with an end is greater than the second threshold Nₘₐₓ then the section end is signalled as a risk area.

In the example, the end corresponding to the risk area 201 is linked to four sections. It is assumed, in the example, that the second threshold Nₘₐₓ is equal to 3.

The second risk area 202 corresponds to a section of the taxiing plan 200 being in connection with another section connected to a runway 204. This signalling allows the pilot to avoid steering towards an incorrect runway, and this may lead to a runway incursion, an event impacting air safety. In practice, the detection of such an area may be performed for example by examining one by one the sections belonging to the taxiing plan 200 and for each of the sections:
by determining a set of path sections to which it is connected with the aid of the airport base connectivities information, and
by detecting whether one of the sections of the set determined is connected directly to a runway, still with the aid of the airport base connectivities information. Two sections are said to be directly connected if these two sections are adjacent, otherwise they have an end in common.

In the example, one of the sections of the taxiing plan 200 is linked to a taxiway itself linked to a runway 204. The end of the taxiing plan section 200 which is linked to the taxiway is signalled as a risk area 202.

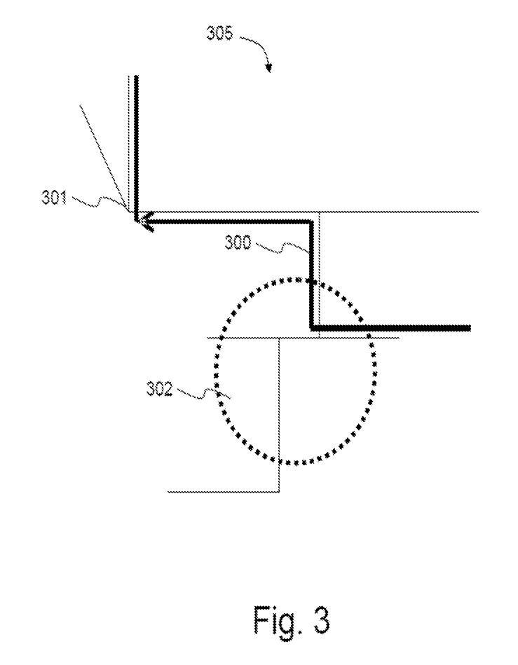

FIG. 3 presents a second example of a taxiing plan 300. As in the previous example, the figure shows a map of the airport 305 signalling the taxiways indicated in the airport base. The taxiing plan 300 is signalled by a thick line and by an arrow signalling the direction of travel of the aircraft. The figure also shows two risk areas 301, 302 detected along the taxiing plan.

The first risk area 301 corresponds to a section of the taxiing plan 300 forming an angle with another adjacent section, that is smaller than a first threshold θₘᵢₙ. This signalling makes it possible to inform the pilot regarding the fact that he will encounter a bifurcation whose paths are sufficiently close for there to be a risk of confusion.

The airport database contains the information about connectivities and it provides the info about the angle between the branches of sections. Therefore, the angles of bifurcation with respect to the course that are scheduled are tested as to whether or not they are smaller than the threshold.

In the example, it is assumed that the angle associated with the signalled risk area is 15° and that the first threshold θₘᵢₙ is 20°.

The second risk area 302 corresponds to a predetermined risk area originating from a dedicated database 106. This base 106 contains notably the areas at high risk of runway incursion (or “Runway Incursion Hotspots”) defined by the authorities which provide the airport maps. These “Hotspots” are signalled by circles centred on the published airport map.

According to a characteristic of the invention, the step of displaying the detected risk areas comprises the displaying on an airport map representing the taxiways, of symbols 401, 402, 403 at the detected risk areas.

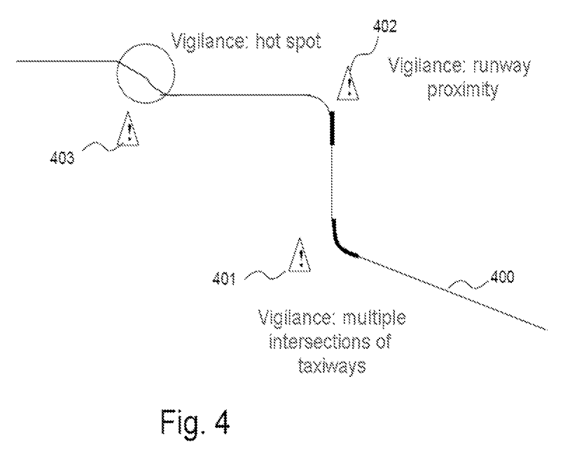

FIG. 4 presents an exemplary display of symbols on an airport map at detected risk areas. In contradistinction to the previous examples, the taxiing plan 400 is represented without the map of the airport so as to simplify the figure. The symbols used in the example are given by way of illustration. The display comprises three symbols 401, 402, 403 corresponding to three risk areas along the taxiing plan.

Optionally, for each risk area the display comprises, in addition to a symbol, a text indicating the nature of the detected risk area. This text may be displayed permanently or appear only subsequent to an action by the pilot on the man-machine interface 106.

The example shows a first symbol 401 signalling a first risk area as well as a first text indicating that the area corresponds to an intersection of multiple taxiways, a second symbol 402 signalling a second risk area as well as a second text indicating that the area corresponds to a runway proximity, a third symbol 403 signalling a third risk area as well as a third text indicating that the area corresponds to an area catalogued in the base of dangerous areas.

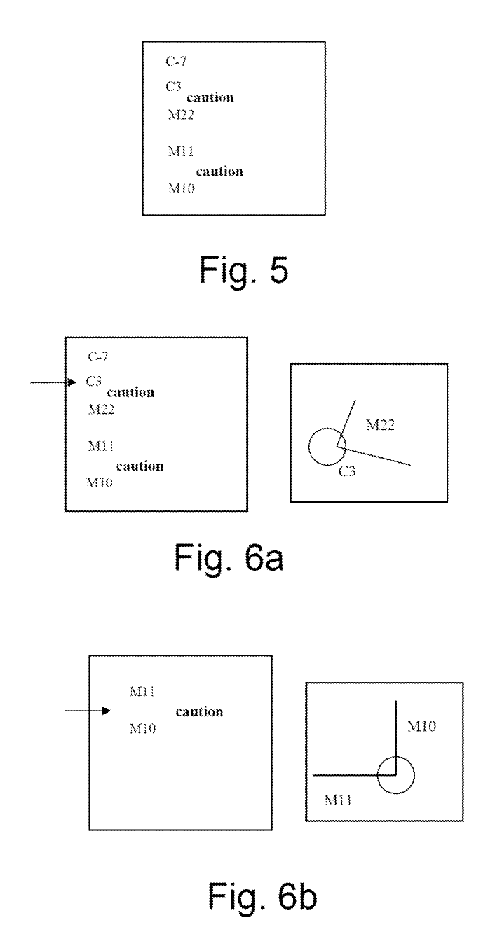

FIG. 5 illustrates an exemplary displaying of a list of sections comprising vigilance messages. According to another characteristic of the invention, the displaying of the taxiing plan comprising a list of sections, the displaying step comprises for each detected risk area, the displaying of a vigilance message inserted into the list of sections before the section associated with the detected risk area.

The list of the example mentions the references of the taxiway sections followed by the taxiing plan (C-7, C3, M22, M10). The displaying step of the method according to the invention allows the insertion of vigilance messages before a section associated with a risk area. In the example, it is assumed that during the detection step, each of the sections M22 and M10 has been associated with a risk area. The vigilance message (for example “caution”) then appears before each of these segments.

According to one embodiment of the invention, the method comprises a step of selection by the pilot of a vigilance message from among the displayed list. The selection means then make it possible to display the map of the airport centred on the section junction comprising a risk area.

FIG. 6a shows a first example of selecting a vigilance message in the list of path sections representing the taxiing plan.

The selection, represented by an arrow on the left of the list, of the first vigilance message, situated before the section M22, results in the modification of the display on the means of display of the map of the airport. The map displayed is centred on the risk area corresponding to the message selected. Here this is the junction between the section M22 and C3 signalled in this example by a circle.

FIG. 6b shows a second example of selecting a vigilance message still in even the list of path sections.

The selection, represented by an arrow on the left of the list, of the first vigilance message, situated before the section M10, results in the modification of the display on the means of display of the map of the airport. The map displayed is centred on the risk area corresponding to the message selected. Here this is the junction between the section M11 and M10 signalled in this example by a circle.

Advantageously, the means for the selection of the messages allow the pilot to pass directly from one vigilance message to the other without selecting the various path sections displayed. This allows the pilot to rapidly view the various areas along the taxiing plan where an error or confusion have a high probability of occurring.

1. A method for preparing the taxiing phase for an aircraft on the basis of an airport database cataloguing by section, the taxiways of an airport and storing, for each section, specific data of geographical position and of connectivity and of a taxiing plan for the aircraft indicating a succession of taxiway sections, said method comprising following steps:
detecting risk areas along the taxiing plan comprising at least one of the following sub-steps
detection of sections adjacent to the taxiing plan forming an angle, with a section of the taxiing plan, that is smaller than a first threshold,
detection of sections of the taxiing plan comprising a number of connections with other sections that is greater than a second threshold, or
detection of the sections of the taxiing plan being in connection with a section connected to a runway;
and,
displaying the detected risk areas.

2. A method for preparing the taxiing phase according to claim 1, wherein the step of displaying the detected risk areas comprises displaying, on an airport map representing the taxiways, symbols at the detected risk areas.

3. A method for preparing the taxiing phase according to claim 1, wherein, the displaying of the taxiing plan comprising a list of sections, the displaying step comprises for each detected risk area, the displaying of a vigilance message signalling the section associated with the detected risk area.

4. A method for preparing the taxiing phase according to claim 3, wherein the step of displaying the detected risk areas comprises displaying, on an airport map representing the taxiways, symbols at the detected risk areas, and
further comprising a step of selecting the vigilance messages making it possible to centre the airport map on the risk area corresponding to the selected vigilance message.

5. A method for preparing the taxiing phase according to claim 1, further comprising a step of acquiring areas at high risk of runway incursion originating from a base of areas at high risk of runway incursion.

6. A system for preparing the taxiing phase for an aircraft comprising an airport database cataloguing by section, the taxiways of an airport and storing, for each section, specific data of geographical position and of connectivity, and a taxiing function calculating a taxiing plan for the aircraft indicating a succession of taxiway sections, said system comprising:
a device adapted to the detection of risk areas along the taxiing plan on the basis of the data of the airport database and of the taxiing plan comprising at least one of the following
means configured for the detection of sections adjacent to the taxiing plan forming an angle, with a section of the taxiing plan, that is smaller than a first threshold,
means adapted to the detection of sections of the taxiing plan comprising a number of connections with other sections that is greater than a second threshold,
means adapted to the detection of the sections of the taxiing plan being in connection with a section connected to a runway;
and
means configured for the displaying of the detected risk areas.

7. A system for preparing the taxiing phase according to claim 6, in which the means configured for the displaying of the detected risk areas comprise an airport map representing the taxiways and symbols at the detected risk areas.

8. A system for preparing the taxiing phase according to one of claim 6, in which the means configured for the displaying of the detected risk areas comprise a list of sections of the taxiing plan and, for each detected risk area, a vigilance message signalling the section associated with the detected risk area.

9. A system for preparing the taxiing phase according to claim 8, in which the means configured for the displaying of the detected risk areas comprise an airport map representing the taxiways and symbols at the detected risk areas, and
further comprising means for selecting the displayed vigilance messages, and means for the synchronization of the displaying of the airport map with the said means for selecting the vigilance messages, configured so that the airport map is centred on the risk area corresponding to the selected vigilance message.

10. A system for preparing the taxiing phase according to claim 6, further comprising means for the acquisition of data originating from a base of areas at high risk of runway incursion in which the means configured for the displaying of the detected risk areas furthermore display the areas at high risk of runway incursion.
